(19) United States
(12) Patent Application Publication
(10) Pub. No.: US 2018/0013671 A1
(43) Pub. Date: Jan. 11, 2018

(54) EMBEDDED COMMUNICATIONS NETWORK OF A VEHICLE

(71) Applicant: AIRBUS OPERATIONS (S.A.S.), Toulouse (FR)

(72) Inventors: Juan LOPEZ, GRENADE (FR); Cedric HATE, PIBRAC (FR)

(21) Appl. No.: 15/639,820

(22) Filed: Jun. 30, 2017

(30) Foreign Application Priority Data
Jul. 11, 2016 (FR) 16 56625

(51) Int. Cl. H04L 12/721; H04L 29/08; H04L 12/715

(52) U.S. Cl. CPC H04L 45/66; H04L 67/12; H04L 45/64

(57) ABSTRACT

An embedded communications network of a vehicle is a deterministic switched Ethernet network using virtual links, including a set of subscribers and a set of switches. A first subscriber is connected to a first switch and a third switch, and a second subscriber is connected to a second switch and to a fourth switch. A first virtual link is formed from the first subscriber to at least the second subscriber via a first subset of switches, and a second virtual link is formed from the first subscriber to at least the second subscriber via a second subset of switches, the switches of the first subset of switches all being separate from the switches of the second subset of switches. The communications network includes at least one connection, used by a third virtual link, between a switch of the first subset and a switch of the second subset.

### CROSS-REFERENCE TO RELATED APPLICATION

This patent application claims priority to French patent application FR 16 56625, filed on Jul. 11, 2016, the entire disclosure of which is incorporated by reference herein.

### TECHNICAL FIELD

The disclosure herein relates to the field of communications networks, and more particularly to embedded communications networks in vehicles, notably aircraft.

### BACKGROUND

An aircraft usually has one or more embedded communications networks to provide communication between embedded devices, particularly embedded computers. In order to meet regulatory requirements concerning aircraft certification, an embedded communications network must be deterministic; that is to say, it must allow information to be transmitted from a transmitter device subscribing to this communications network to one or more receiver devices subscribing to this communications network, with a transmission time which is shorter than a predetermined duration and a guarantee that no information will be lost across the network. The ARINC 664 standard, Part 7, defines a deterministic embedded avionic communications network, based on full-duplex Ethernet technology. Such a network may, for example, be an AFDX® communications network. In a network according to the ARINC 664 standard, Part 7, each device subscribing to the communications network is connected to a network switch, and the communication between the different devices use virtual links predefined in the definition and configuration of the network. A virtual link is defined between a transmitter device and one or more receiver devices, via one or more network switches. Each virtual link follows a specified path in the network. A bandwidth is allocated to each virtual link, and the routing of the different virtual links of the network is carried out in such a way that the sum of the bandwidths allocated to the virtual links following the same physical connection does not exceed the bandwidth supported by the physical connection. This is necessary in order to ensure the determinism of the network. All communications between devices are defined in advance, by the definition of the virtual links, to enable the switches to be configured: each switch has a configuration table based on the virtual links passing through this switch. The configuration of each switch is downloaded into the switch before it is used. To ensure sufficient availability of communications between the different devices, the communications network 5 is redundant with two layers, A and B, as in the example shown in FIG. 1a: the switches, the physical connections and the virtual links are duplicated in an identical manner in each layer A and B. The various devices connected to the communications network each have two network interfaces, connected, respectively, to the A and B layers of the communications network. Thus the network shown in the drawing has switches 12a, 12b, . . . 12h in layer A and similar switches to these, namely 22a, 22b, . . . 22h respectively, in layer B. Each of the subscribers 10a, 10b, . . . 10g to the communications network is connected to two similar switches in the two layers A and B: for example, subscriber 10a is connected to switches 12a and 22a, subscriber 10d is connected to switches 12h and 22h, subscriber 10e is connected to switches 12b and 22b, and so on. A virtual link VL1, for communications from subscriber 10d to subscriber 10g, is shown in FIG. 1b. This figure is similar to FIG. 1a, references having been omitted for the sake of readability. In practice, the virtual link VL1 takes the form of a virtual link VL1_{A} in layer A (via switches 12h and 12g) and a virtual link VL1_{B} in layer B (via switches 22h and 22g). These two virtual links are identical in terms of their characteristics (bandwidth, etc.) and their number VL1. A modern aircraft may have a large number of switches, for example 14 switches in some aircraft. The resulting weight, overall dimensions and electricity consumption are such that it would be preferable to reduce them in order to improve the performance of the aircraft.

### SUMMARY

An object of the present disclosure herein is, notably, to provide a solution to these problems. It relates to an embedded communications network of a vehicle, the communications network being a deterministic switched Ethernet network using virtual links and comprising:
a set of subscribers; and
a set of switches,
in which a first subscriber of the set of subscribers is connected by a first physical connection to a first switch of the set of switches, a second subscriber of the set of subscribers is connected by a second physical connection to a second switch of the set of switches, and a first virtual link is formed from the first subscriber to at least the second subscriber via a first subset of switches of the set of switches, this first subset of switches comprising the first switch and the second switch.

This network is characterized in that the first subscriber is also connected by a third physical connection to a third switch of the set of switches, the second subscriber is connected by a fourth physical connection to a fourth switch of the set of switches,

a second virtual link is formed from the first subscriber to at least the second subscriber via a second subset of switches of the set of switches, this second subset of switches comprising the third switch and the fourth switch, the switches of the first subset of switches are all separate from the switches of the second subset of switches, and
the communications network comprises at least one connection, used by a third virtual link, between a switch of the first subset of switches and a switch of the second subset of switches.

Thus, if a switch of one of the subsets of switches fails, or if a physical connection between two switches is interrupted, communication continues to be available between the first subscriber and the second subscriber, because of the virtual link via the switches of the other subset of switches. Since the switches of the first subset of switches are separate from the switches of the second subset of switches, the first virtual link can be totally segregated from the second virtual link, ensuring that a failure of single switch or the interruption of a single physical connection cannot affect the first virtual link and the second virtual link simultaneously. Furthermore, since the communications network comprises at least one connection, used by a third virtual link, between a switch of the first subset of switches and a switch of the second subset of switches, the switches of the first subset of switches and the switches of the second subset of switches belong to a single network layer. It is therefore unnecessary to duplicate the switches and physical connections in two network layers as in the prior art; consequently, the weight, overall dimensions and electricity consumption can be reduced.

Advantageously, the first subscriber is configured to transmit data frames redundantly over the first virtual link and over the second virtual link to at least the second subscriber, and the second subscriber is configured to manage the redundancy of the data frames received from the first subscriber.

In a particular embodiment, the communications network comprises at least another virtual link, formed in the communications network, to provide communication between transmitter subscriber and a receiver subscriber, this communication being non-redundant.

According to one embodiment, the subscribers of the set of subscribers and the switches of the set of switches are configured to communicate over the communications network according to a communications protocol compatible with the ARINC 664 standard, part 7. According to a first alternative, the data frames travelling over each of the various virtual links comprise a destination MAC address comprising a data field whose value is equal to the number of the virtual link in question, and another data field having a predefined constant value. According to a second alternative, the data frames travelling over each of the various virtual links comprise a destination MAC address comprising a data field whose value is equal to the number of the virtual link in question, a data field having a predefined constant value, and another data field whose value is equal to:
an identification number of a set of redundant virtual links, if the virtual link in question is redundant with at least one other virtual link;
another predefined constant, if the virtual link in question is not redundant with another virtual link.

Advantageously, the second subscriber is configured to manage the redundancy of a frame received when the value of this other data field is equal to an identification number of a set of redundant virtual links, and to accept this received frame in all cases if the value of this other data field is equal to the other predefined constant.

The disclosure herein also relates to a vehicle comprising a communications network such as the aforesaid network.

### BRIEF DESCRIPTION OF THE DRAWINGS

The disclosure herein will be more readily understood from the following description and the accompanying example figures.

FIGS. 1a and 1b, described above, illustrate in a simplified manner an example of a prior art communications network.

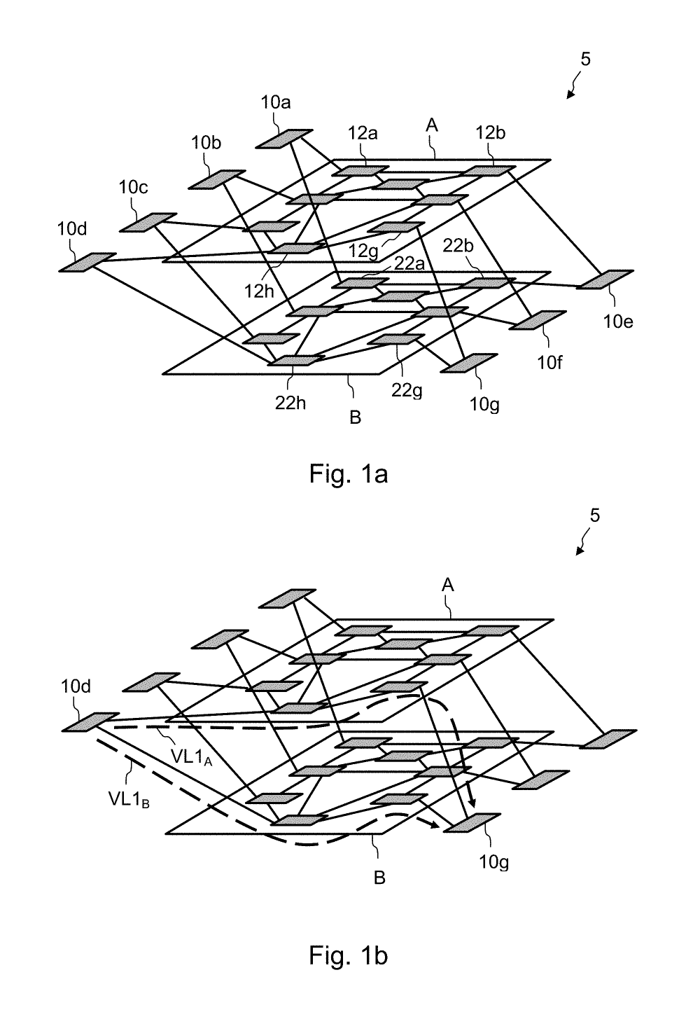

FIG. 2 shows a communications network according to one embodiment of the disclosure herein.

FIG. 3 shows in a schematic manner the functional architecture of a subscriber to a communications network, according to a particular embodiment of the disclosure herein.

FIGS. 4 and 6 show examples of destination MAC addresses corresponding to two particular alternative embodiments of the disclosure herein.

FIGS. 5 and 7 show examples of configuration tables corresponding to these two alternatives.

### DETAILED DESCRIPTION

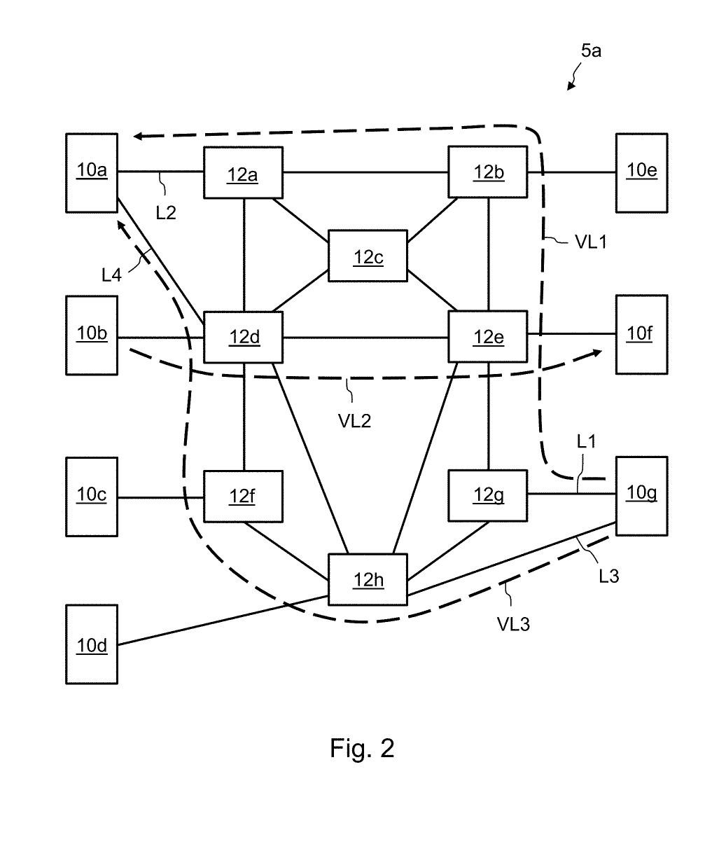

The communications network 5a shown in FIG. 2 has a single layer comprising a set of switches 12a, 12b . . . 12h, together with a set of physical connections, each formed between two switches of the set of switches. The communications network also comprises a set of subscribers 10a, 10b, . . . 10g, each connected to at least one switch of the set of switches. A first subscriber 10g is connected by a first physical connection L1 to a first switch 12g, and a second subscriber 10a is connected by a second physical connection L2 to a second switch 12a. A first virtual link VL1 is formed from the first subscriber 10g to at least the second subscriber 10a, via a first subset of switches of the set of switches, this first subset of switches comprising the first switch 12g, switches 12e and 12b, and the second switch 12a. Furthermore, the first subscriber 10g is also connected by a third physical connection L3 to a third switch 12h of the set of switches, and the second subscriber 10a is connected by a fourth physical connection L4 to a fourth switch 12d of the set of switches. A second virtual link VL3 is formed from the first subscriber to at least the second subscriber via a second subset of switches of the set of switches, this second subset of switches comprising the third switch 12h, a switch 12f, and the fourth switch 12d. The switches 12g, 12e, 12b and 12a of the first subset of switches are all separate from the switches 12h, 12f and 12d of the second subset of switches, so that the first virtual link and the second virtual link are segregated.

The communications network also comprises at least one connection, used by a third virtual link VL2, between the switch 12e of the first subset of switches and the switch 12d of the second subset of switches. The fact that there is at least one connection between switches of the two subsets of switches means that these two subsets are not independent, but form part of the same layer of the communications network 5a. The segregation and independence of the first virtual link VL1 and the second virtual link VL3, for their part, are due to the fact that the switches of the first subset of switches are all separate from the switches of the second subset of switches.

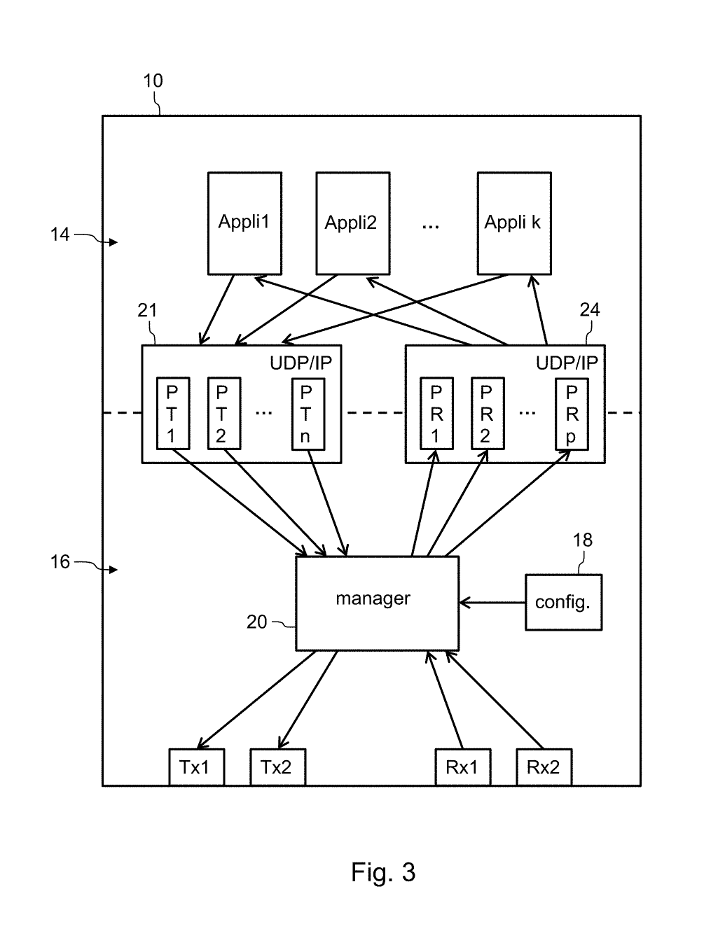

The functional architecture of the first subscriber 10g and the second subscriber 10a corresponds, for example, to that shown in FIG. 3 for a subscriber 10 to the communications network. The subscriber comprises an application part 14 and a network interface part 16. The application part comprises a set of applications appli1, appli2 . . . appli k. The application part and the network interface part are interfaced with one another by a transmission communication stack 21 and a reception communication stack 24. These two communication stacks are, for example, of the UDP/IP. Each of them comprises a set of communication ports, namely PT1, PT2 . . . PTn and PR1, PR2 . . . PRp respectively. If one of the applications appli1, appli2 . . . appli k of the application part has to send information to another subscriber via the communications network, this application writes these data elements to a port of the communication stack 21. To receive information from another subscriber via the communications network, an application reads this information from a port of the communication stack 24. The network interface part 16 comprises a communications manager 20, connected to a configuration memory 18. This configuration memory contains, for example, one or more configuration tables. The network interface part 16 further comprises two communication ports Tx1 and Tx2 for transmission to the communications network, together with two communication ports Rx1 and Rx2 for reception from the communications network. The communications manager 20 is connected to the two transmission communication ports Tx1 and Tx2 and to the two reception communication ports Rx1 and Rx2. When the subscriber 10 is connected to the communications network and is, for example, one of the subscribers 10a or 10g mentioned above with reference to FIG. 2, the ports Tx1 and Rx1 are connected to one switch, on the one hand, and the ports Tx2 and Rx2 are connected to another switch, on the other hand, thereby providing two segregated redundant links between the subscriber 10 and other subscribers, via these two switches and the communications network. However, the subscriber may also communicate in a non-redundant manner with some other subscribers: thus the subscriber may, on the one hand, communicate in a redundant manner over redundant virtual links with a first set of subscribers, and, on the other hand, communicate in a non-redundant manner, over non-redundant virtual links, with a second set of subscribers.

The communications manager 20 repetitively reads the data present on the various communication ports PT1, PT2 . . . PTn of the transmission communication stack 21. These data correspond to the information written to the communication ports by the applications appli1, appli2 . . . appli k. The communications manager 20 also reads the configuration memory 18 in order to acquire communication configuration information associated with each communication port, in particular the fact that the communication is redundant or non-redundant, as well as the associated virtual link(s). On the basis of the above information, for each of the communication ports PT1, PT2 . . . PTn, the communications manager encapsulates the data read on this communication port into data frames which it sends to the two communication ports Tx1 and Tx2 in the case of redundant communication, or to only one of the communication ports Tx1 or Tx2 in the case of non-redundant communication.

In reception, the communications manager 20 reads the data frames received on the communication ports Rx1 and Rx2. It analyzes each data frame to identify the corresponding virtual link. It also reads the configuration information contained in the memory 18, in order to determine a communication port PR1, PR2 . . . PRp associated with this virtual link. If the communication is non-redundant, the communications manager 20 writes the data obtained from the data frame to this communication port of the reception communication stack 24. If the communication is redundant, it checks whether a first redundant data frame has already been received. If this is the case, it disregards the data frame received. Otherwise, it writes the data obtained from the data frame to the communication port of the reception communication stack 24.

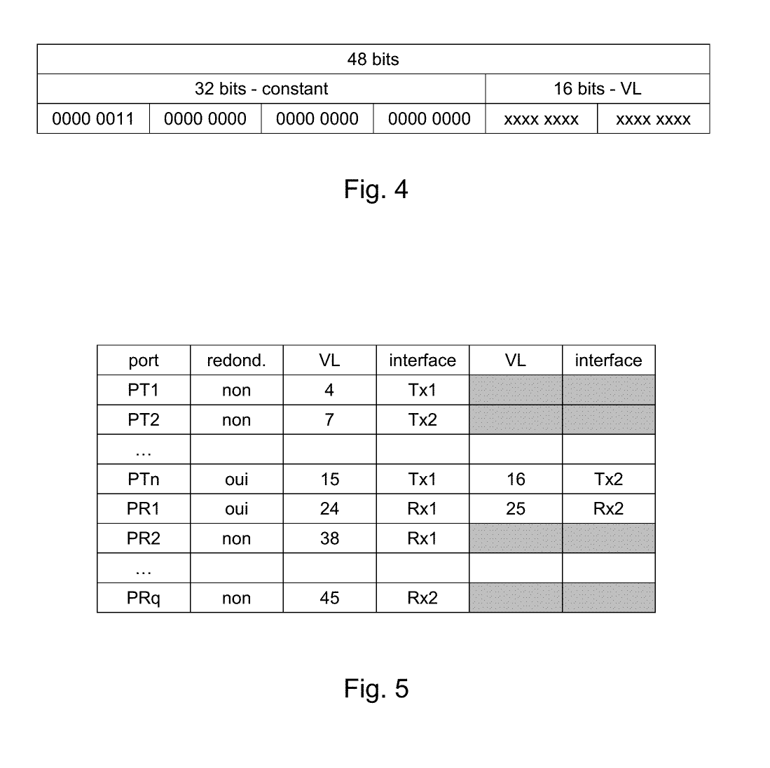

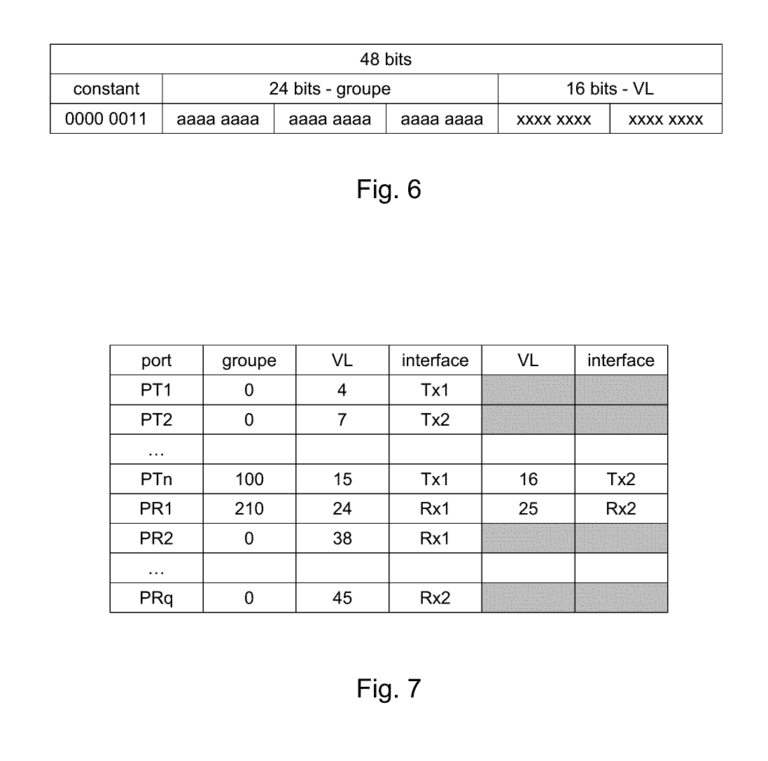

According to one embodiment, the subscriber 10 is configured to communicate over the communications network according to a communications protocol compatible with the ARINC 664 standard, part 7. According to a first alternative, the data frames transmitted and/or received by the subscriber 10 over virtual links of the communications network via the communication ports Tx1, Tx2, Rx1, Rx2 comprise a destination MAC address as shown by way of example in FIG. 4. This destination MAC address is coded on 48 bits and comprises a 16-bit data field whose value is equal to the number of the virtual link (VL) in question, and another constant 32-bit data field, having a predefined constant value, which for example is equal to 0000 0011 0000 0000 0000 0000 0000 0000, as shown in the drawing. This destination MAC address corresponds to an ordinary destination MAC address according to the ARINC 664 standard, part 7. The configuration memory 18 contains a configuration table, corresponding for example to that shown in FIG. 5. In transmission, when the communications manager 20 reads the data present on a communication port of the transmission communication stack 21, it reads the configuration information associated with this communication port from the configuration memory 18. In the example shown in FIG. 5, the data obtained from the port PT1 must be transmitted in a non-redundant manner over virtual link number 4, using the communication port Tx1. Therefore, the communications manager 20 constructs a data frame in which it encapsulates the data read from the communication port PT1 of the transmission communication stack 21, adding the virtual link number 4 in the destination MAC address, and then transmits this data frame over the communications network, using the communication port Tx1. In the example shown in FIG. 5, the data obtained from the communication port PT2 must be transmitted in a non-redundant manner over virtual link number 7, using the communication port Tx2. The data obtained from the communication port PTn must be transmitted in a redundant manner, on the one hand over virtual link number 15, using the communication port Tx1, and on the other hand over virtual link number 16, using the communication port Tx2. For this purpose, the communications manager 20 constructs a first data frame in which it encapsulates the data read from the communication port PTn of the transmission communication stack 21, adding the virtual link number 15 in the destination MAC address. It also adds a sequence number in a suitable field of the data frame, for the purpose of redundancy management in reception, and then transmits this data frame over the communications network, using the communication port Tx1. The communications manager 20 also constructs a second data frame in which it encapsulates the data read from the communication port PTn of the transmission communication stack 21, adding the virtual link number 16 in the destination MAC address. It also adds the same sequence number in a field of the data frame, for the purpose of redundancy management in reception, and then transmits this data frame over the communications network, using the communication port Tx2. In reception, when the communications manager 20 receives a data frame on one of the communication ports Rx1 or Rx2, it analyzes this data frame to identify the corresponding virtual link number, and searches, in the configuration memory 18, for the configuration information corresponding to this virtual link. In the example shown in FIG. 5, if the virtual link number is 24 or 25, the communication is redundant over the two virtual links 24 and 25, so that the communications manager 20 has to manage the redundancy of the data frames received on the communication ports Rx1 and Rx2. The redundancy is managed in reception by the aforementioned sequence number: the communications manager 20 analyzes the received data frame in order to identify the sequence number. For this purpose, it searches in a memory to discover whether a data frame having the same sequence number has already been received. If this is the case, it rejects the received data frame. Otherwise, it records the sequence number in the memory, searches in the configuration table for the communication port of the reception communication stack 24 corresponding to the virtual link, extracts the useful data from the data frame, and writes these data to the communication port. In the example shown in FIG. 5, the communication port corresponding to one of the virtual links 24 or 25 is the communication port PR1. If the virtual link number is 38, the communication is not redundant, and the communication port of the reception communication stack 24 corresponding to this virtual link is the communication port PR2. Consequently, the communications manager 20 does not need to manage the redundancy: it extracts the useful data from the data frame, and writes these data to the communication port PR2. Similarly, if the virtual link number is 45, the communication is not redundant, and the communication port of the reception communication stack 24 corresponding to this virtual link is the communication port PRq.

According to a second alternative, the data frames transmitted and/or received by the subscriber 10 over virtual links of the communications network via the communication ports Tx1, Tx2, Rx1, Rx2 comprise a destination MAC address coded on 48 bits, comprising a 16-bit data field whose value is equal to the number of the virtual link (VL) in question, a data field on 8 bits having a predefined constant value, for example equal to 0000 0011, and another 24-bit data field, called a group in the remainder of the description, whose value is equal to:
a predefined constant, if the virtual link in question is not redundant with another virtual link. The predefined constant is, for example, equal to zero: the destination MAC address is then similar to that described with reference to FIG. 4;
an identification number of a set (or group) of redundant virtual links, if the virtual link in question is redundant with at least one other virtual link, as shown in FIG. 6.

In transmission, when the communications manager 20 reads the data present on a communication port of the transmission communication stack 21, it reads the configuration information associated with this communication port from the configuration memory 18. An example of a configuration table is shown in FIG. 7. The configuration table comprises a column entitled “group” whose value is equal either to zero, if the data obtained from the communication port are to be transmitted in a non-redundant manner, or to the identification number of a set of redundant virtual links, if the data obtained from the communication port are to be transmitted in a redundant manner. In the example shown in FIG. 7, the value of the group corresponding to the communication port PT1 is equal to 0. Consequently, the data obtained from the port PT1 must be transmitted in a non-redundant manner over virtual link number 4, using the communication port Tx1. Therefore, the communications manager 20 constructs a data frame in which it encapsulates the data read from the communication port PT1 of the transmission communication stack 21, adding the virtual link number 4 in the destination MAC address, the group field of the destination MAC address being left equal to zero, and then transmits this data frame over the communications network, using the communication port Tx1. Similarly, the value of the group corresponding to the communication port PT2 is equal to 0. Consequently, the data obtained from the communication port PT2 must be transmitted in a non-redundant manner over virtual link number 7, using the communication port Tx2. The value of the group corresponding to the communication port PTn is equal to 100. Consequently, the data obtained from the communication port PTn must be transmitted in a redundant manner, on the one hand over virtual link number 15, using the communication port Tx1, and on the other hand over virtual link number 16, using the communication port Tx2. For this purpose, the communications manager 20 constructs a first data frame in which it encapsulates the data read from the communication port PTn of the transmission communication stack 21, adding the virtual link number 15 in the destination MAC address. It also adds, in the group field of the destination MAC address, the group number 100 corresponding to the set of virtual links 15 and 16. It also adds a sequence number in a suitable field of the data frame, for the purpose of redundancy management in reception, and then transmits this data frame over the communications network, using the communication port Tx1. The communications manager 20 also constructs a second data frame in which it encapsulates the data read from the communication port PTn of the transmission communication stack 21, adding the virtual link number 16 in the destination MAC address. It also adds the group number 100 in the group field of the destination MAC address. It also adds the same sequence number in a field of the data frame, for the purpose of redundancy management in reception, and then transmits this data frame over the communications network, using the communication port Tx2. In reception, when the communications manager 20 receives a data frame on one of the communication ports Rx1 or Rx2, it analyzes this data frame to identify the corresponding virtual link number and the value of the group field. When the value of the group field is other than zero, the communications manager 20 must manage the redundancy of the received data frame. In the example shown in FIG. 7, if the value of the group is equal to 210, corresponding to the virtual links 24 and 25, the communication is redundant over the two virtual links 24 and 25, so that the communications manager 20 has to manage the redundancy of the data frames received on the communication ports Rx1 and Rx2. The redundancy is managed in reception by the aforementioned sequence number: the communications manager 20 analyzes the received data frame in order to identify the sequence number. For this purpose, it searches in a memory to discover whether a data frame having the same sequence number has already been received. If this is the case, it rejects the received data frame. Otherwise, it records the sequence number in the memory, searches in the configuration table for the communication port of the reception communication stack 24 corresponding to the virtual link or to the group number in question, extracts the useful data from the data frame, and writes these data to the communication port. In the example shown in FIG. 7, the communication port corresponding to one of the virtual links 24 or 25 is the communication port PR1. If the virtual link number is 38, the value of the group number is zero, so that the communication is not redundant, and the communication port of the reception communication stack 24 corresponding to this virtual link is the communication port PR2. The value of the group number being equal to zero, the communications manager 20 does not need to manage the redundancy, and it accepts the received data frame: it extracts the useful data from the data frame, and writes these data to the communication port PR2. Similarly, if the virtual link number is 45, the value of the group number is zero, so that the communication is not redundant, and the communication port of the reception communication stack 24 corresponding to this virtual link is the communication port PRq.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the disclosure invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An embedded communications network of a vehicle, the communications network being a deterministic switched Ethernet network using virtual links and comprising:
a set of subscribers; and
a set of switches,
wherein a first subscriber of the set of subscribers is connected by a first physical connection to a first switch of the set of switches, a second subscriber of the set of subscribers is connected by a second physical connection to a second switch of the set of switches, and a first virtual link is formed from the first subscriber to at least the second subscriber via a first subset of switches of the set of switches, the first subset of switches comprising the first switch and the second switch; and
wherein the first subscriber is also connected by a third physical connection to a third switch of the set of switches, the second subscriber is connected by a fourth physical connection to a fourth switch of the set of switches, a second virtual link is formed from the first subscriber to at least the second subscriber via a second subset of switches of the set of switches, the second subset of switches comprising the third switch and the fourth switch, the switches of the first subset of switches are all separate from the switches of the second subset of switches, and
the communications network also comprises at least one connection, used by a third virtual link, between a switch of the first subset of switches and a switch of the second subset of switches.

2. The communications network of claim 1, wherein the first subscriber is configured to transmit data frames redundantly over the first virtual link and over the second virtual link to at least the second subscriber, and the second subscriber is configured to manage redundancy of the data frames received from the first subscriber.

3. The communications network of claim 2, comprising at least another virtual link, formed in the communications network, to provide communication between a transmitter subscriber and a receiver subscriber, this communication being non-redundant.

4. The communications network of claim 1, comprising at least another virtual link, formed in the communications network, to provide communication between a transmitter subscriber and a receiver subscriber, this communication being non-redundant.

5. The communications network of claim 1, wherein subscribers of the set of subscribers and the switches of the set of switches are configured to communicate over the communications network according to a communications protocol compatible with ARINC 664 standard, part 7.

6. The communications network of claim 5, comprising data frames travelling over each of the virtual links and wherein the data frames comprise a destination MAC address comprising a data field whose value is equal to a number of a virtual link in question, and another data field having a predefined constant value.

7. The communications network of claim 5, comprising data frames travelling over each of the virtual links and wherein the data frames comprise a destination MAC address comprising a data field whose value is equal to a number of a virtual link in question, a data field having a predefined constant value, and another data field whose value is equal to:
an identification number of a set of redundant virtual links, if the virtual link in question is redundant with at least one other virtual link;
another predefined constant, if the virtual link in question is not redundant with another virtual link.

8. The communications network of claim 7, wherein the second subscriber is configured to manage redundancy of a frame received when a value of this other data field is equal to an identification number of a set of redundant virtual links, and to accept this received frame in all cases if the value of this other data field is equal to the other predefined constant.

9. A vehicle comprising a communications network of claim 1.
